(19) United States
(12) Patent Application Publication
(10) Pub. No.: US 2013/0111343 A1
(43) Pub. Date: May 2, 2013

(54) LOAD BALANCING OF USER INTERFACE SCRIPT EXECUTION

(71) Applicants: Gerd M. Ritter, Heidelberg (DE); Tim Kornmann, Wiesloch (DE); Dirk Stumpf, Graben-Neudorf (DE); René Gross, Heidelberg (DE)

(72) Inventors: Gerd M. Ritter, Heidelberg (DE); Tim Kornmann, Wiesloch (DE); Dirk Stumpf, Graben-Neudorf (DE); René Gross, Heidelberg (DE)

(21) Appl. No.: 13/281,933

(22) Filed: Oct. 26, 2011

(51) Int. Cl. G06F 3/00

(52) U.S. Cl. 715/704

(57) ABSTRACT

A computer-implemented system may include reception, from a user interface client application, of an instruction to execute a user interface script conforming to a user interface component model, and determination of whether to execute the user interface script in the user interface client application or in a user interface backend application. If it is determined to execute the user interface script in the user interface client application, first program code associated with the user interface script is executed in the user interface client application, and if it is determined to execute the user interface script in the user interface backend application, second program code associated with the user interface script is executed in the user interface backend application.

### FIELD

Some embodiments relate to user interfaces for accessing enterprise services. More specifically, some embodiments relate to systems to efficiently apportion the execution of user interface scripts between a client user interface application and a corresponding backend system.

### BACKGROUND

According to a service-oriented architecture, a backend service layer provides services (i.e., business functionality) to service consumers, typically via Web protocols. FIG. 1 is a block diagram illustrating one such scenario. Typical service consumers use this business functionality to provide user interfaces for accessing data from and submitting data to the backend service layer, application-to-application or business-to-business integration, output management (e.g., printing), spreadsheet download, etc. Service consumers of different types, or even of a same type, may access the backend service layer in different ways. Therefore, the services provided by the backend service layer are not particularly adapted to the requirements of any particular service consumer.

A backend service layer exposes complex services to orchestrate the underlying business logic. Typically, a user interface developer is unconcerned with such orchestration and is concerned only with user interaction and the exposure of data and events on the user interface. Therefore, the developer simply binds user interface data entities of a user interface model to entities of the backend service layer, and then develops user interface logic (e.g., logic for computing user interface indicators or coloring/hiding fields) in terms of the user interface data model.

More specifically, a developer creates a user interface by adding user interface elements to screen layout patterns and binding the user interface elements to data fields of services offered by the backend service layer. This binding facilitates the transmission of data to and from the backend service layer. The user interfaces are rendered on the client side by runtime code of a user interface client application which executes, for example, within a Web browser.

Some operations of the user interface logic might require access to backend services. Shifting this execution load to the user interface client may reduce the overall backend load and associated costs. However, this shift may also adversely affect roundtrip optimization, thereby increasing user response time and network load. For example, user response time may increase if the user interface client submits data requests to the backend layer multiple times for one user interaction, since data or service execution from the backend layer from prior roundtrips may be missed. Moreover, transferring the execution of user interface logic to the backend layer requires the backend layer to understand the user interface model.

### BRIEF DESCRIPTION OF THE DRAWINGS

FIG. 1 is a block diagram of a service-oriented architecture.

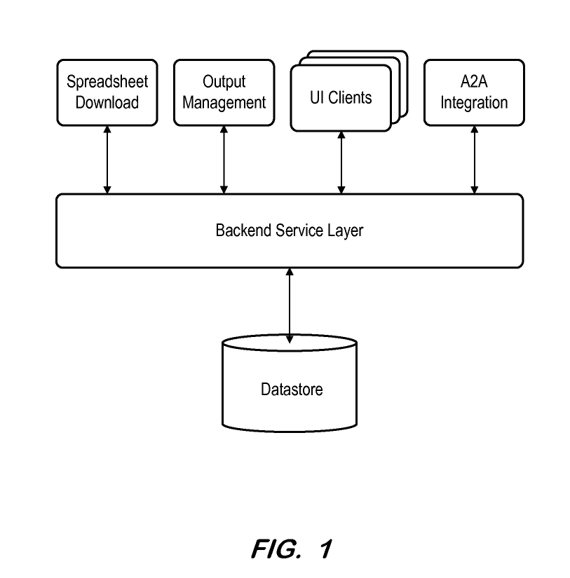

FIG. 2 is a block diagram of a system according to some embodiments.

FIG. 3 is a flow diagram of process steps according to some embodiments.

FIG. 4 is a flow diagram of process steps according to some embodiments.

FIG. 5 is a detailed block diagram of a system according to some embodiments.

FIG. 6 is a block diagram of a computing system according to some embodiments.

### DETAILED DESCRIPTION

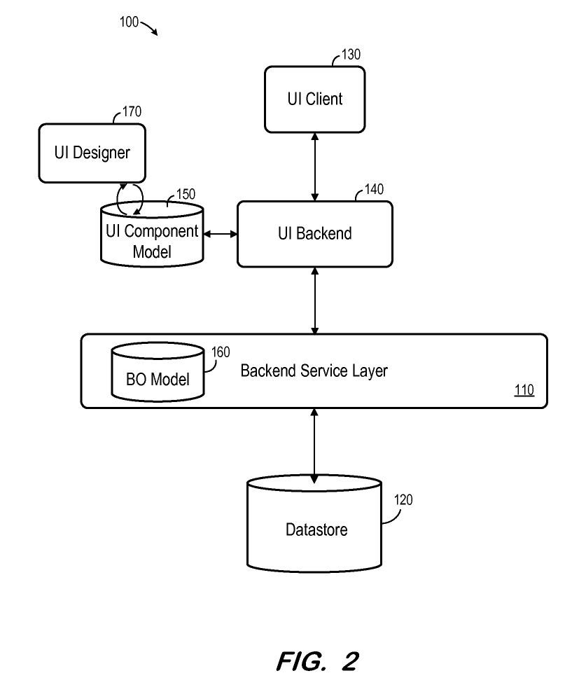

FIG. 2 is a detailed block diagram of system 100 according to some embodiments. System 100 includes backend service layer 110, datastore 120, user interface (UI) client 130, UI backend 140, UI component model 150, business object model 160 and UI designer 170. FIG. 2 represents a logical architecture for describing some embodiments, and actual implementations may include more or different components arranged in any manner.

Backend service layer 110 may comprise an enterprise services infrastructure and/or any implementation for providing services according to a service-oriented architecture paradigm. The primary entities of backend service layer 110 are “business objects”, which are software models defined by metadata of BO model 160 and representing real-world entities involved in business transactions. For example, a business object may represent a business document such as a sales order, a purchase order, or an invoice. A business object may also represent master data objects such as a product, a business partner, or a piece of equipment. Particular documents and master data objects (e.g., SalesOrder SO4711, ACME corporation) are represented by instances of their representing business object, or business object instances. Business objects expose their data in a complex, normalized data tree which consists of nodes containing attributes, actions (executing business logic on a node) and associations to other nodes.

As described above, backend service layer 110 may provide services to one or more service consumers. The services are provided by executing processes conforming to business object model 160. According to the illustrated embodiment, the services may include retrieving, creating, modifying and/or deleting the data of business object instances stored in datastore 120. Datastore 120 may comprise any one or more systems to store business data. Such systems include, but are not limited to, relational database systems, Online Analytical Processing (OLAP) database systems, data warehouses, application servers, and flat files.

UI designer 170 may be operated by a developer to design user interfaces based on UI component model 150. UI component model 150 may be suited to implementation of a user interface. For example, various UI elements, such as drop-down menus, trees, and fact sheets, are defined in the UI component model 150. The developer adds these UI elements to screen layout patterns and binds the elements to entities of BO model 160.

In contrast to BO model 160, little or no business logic may be modeled within UI component model 150. Accordingly, UI designer 170 may allow the developer to create UI scripts to implement UI-related logic. According to some embodiments, these UI scripts may be executed by UI client 130 and/or UI backend 140. The developer may specify the execution entity (i.e., UI client 130 or UI backend 140) which is to be used to execute a UI script. Alternatively, the developer may indicate that the execution entity is to be determined dynamically during backend load creation and/or runtime. The developer may also specify criteria to be considered during this determination.

UI client 130 comprises an application to render user interfaces which were designed based on UI component model 150. That is, specific drop-down menus, trees, fact sheets, etc. rendered by UI client 130 according to a user interface are instances of their corresponding objects defined in UI component model 150. UI client 130 is capable of executing UI scripts as described herein. In this regard, UI scripts to be executed by UI client 130 are compiled into code which is executable by UI client 130.

According to some embodiments, UI client 130 is located at a client or user site, while the other elements of system 100 are housed at a provider site and may provide services to other UI clients located at the same or another user site. The other elements need not always be accessible to UI client 130. That is, UI client 130 may operate in an “offline” mode.

UI backend 140 provides communication between UI client 130 and backend service layer 110. Generally, UI backend 140 receives a UI request which conforms to UI component model 150 from UI client 130, communicates with backend service layer 110 to fulfill the request, and provides a response which conforms to UI component model 150 to UI client 130. According to some embodiments, UI backend 140 is also capable of executing UI scripts which have been compiled into code which is executable by UI backend 140.

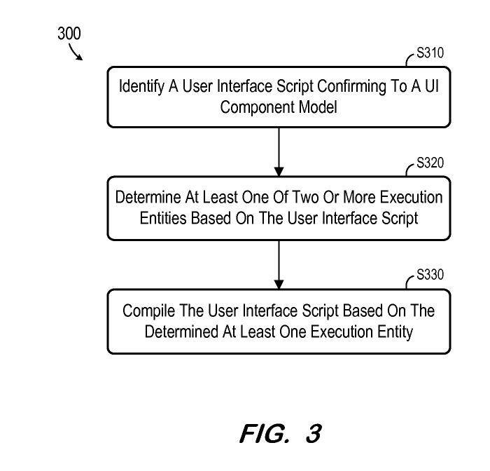

FIG. 3 comprises flow diagram of process 300 according to some embodiments. In some embodiments, various hardware elements of system 100 execute program code to perform process 300. All processes mentioned herein may be embodied in processor-executable program code stored on one or more of non-transitory computer-readable media, such as a floppy disk, a CD-ROM, a DVD-ROM, a Flash drive, and a magnetic tape. In some embodiments, hard-wired circuitry may be used in place of, or in combination with, program code for implementation of processes according to some embodiments. Embodiments are therefore not limited to any specific combination of hardware and software.

Process 300 may be executed after a developer has designed a user interface conforming to a UI component model. As described above, the user interface may include one or more UI scripts to implement UI logic. Accordingly, at S310, a UI script conforming to a UI component model is identified.

S310 may occur during compilation of a user interface. As is known in the art, compilation may include generation of appropriate backend loads and runtime entities based on the user interface, BO model 150 and UI component model 160. Unlike conventional systems, however, at least one of two or more execution entities is determined at S320 based on the UI script. An execution entity refers to the service-oriented architecture element that will (or may) execute the UI script. With respect to system 100, the execution entities may include UI client 130 and UI backend 140.

The developer of the UI script may provide an indication (e.g., a flag) of the entities which may execute the script. For example, the developer may explicitly indicate that the UI script is to be executed in the UI client, in which case the UI client is determined as the execution entity at S320.

According to some embodiments of S320, the UI script is analyzed to determine various characteristics thereof. For example, in some embodiments, S320 includes determination of whether the UI script accesses any other backend services, is part of a backend operation chain, directly influences a succeeding backend operation, is an integral part of another backend operation, or requires other backend features as a pre-requisite. If the UI script exhibits any one of these characteristics, then the UI backend is determined as the execution entity at S320. Otherwise, the UI client is determined as the execution entity.

Some embodiments also or alternatively perform the above analysis at runtime. In such a case, the UI script may be executed either by the UI client or by the UI backend, depending on the result of the analysis. Accordingly, both the UI client and the UI backend are determined as execution entities at S320.

Next, at S320, the UI script is compiled based on the determined at least one execution entity. For example, the UI script is compiled into UI client-executable code (e.g., Web browser virtual machine-language code) if the determined at least one execution entity includes the UI client, and is compiled into UI backend-executable code (e.g., ABAP classes) if the determined at least one execution entity includes the UI backend. As mentioned above, S330 may include compiling the UI script into UI client-executable code and UI backend-executable code if the UI client and the UI backend are each determined to be execution entities. In some embodiments, both the UI client and the UI backend support the same scripting engine and therefore separate compilation for each execution entity is unnecessary.

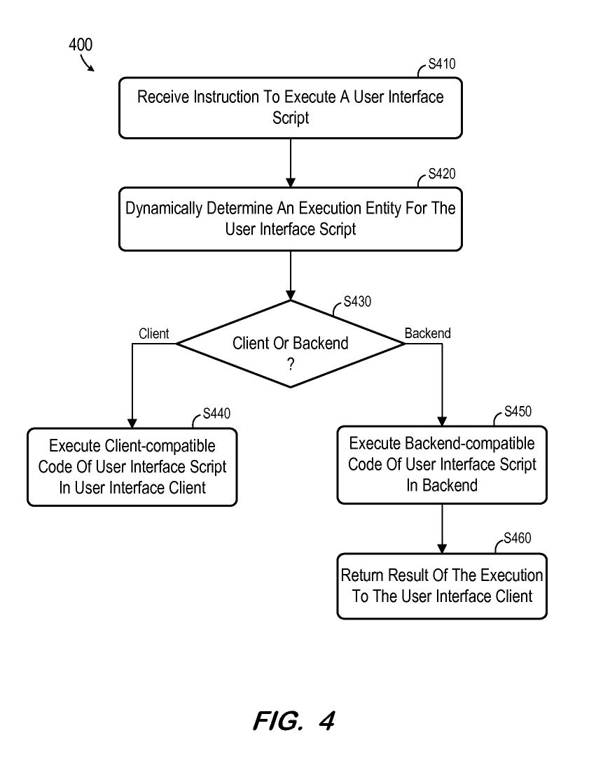

FIG. 4 illustrates process 400 to be executed at runtime according to some embodiments. For example, a user may operate UI client 130 to retrieve a user interface from UI backend 140 and to display the user interface. Initially, at 5410, an instruction is received to execute a UI script. The instruction may result from triggering of a user interface event (e.g., selection of a drop-down menu) and/or a user interface data change (e.g., changing a value in a displayed field).

An execution entity for the user interface script is dynamically determined at S420. The determination may be performed by UI client 130 in a similar manner to that described above with respect to S320. Specifically, UI client 130 may determine whether the UI script accesses any other backend services (e.g., in SAP Business ByDesign, via Local Client Proxy), is part of a backend operation chain (e.g., OnAction), directly influences a succeeding backend operation (e.g., OnParameterLoad), is an integral part of another backend operation (e.g., OnDataLoad, OnAssociation), or requires other backend features as a pre-requisite (e.g., Transformation Definitions).

If the UI script possesses none of these characteristics, the UI client is determined as the execution entity at S420 and flow proceeds from S430 to S440 to execute the client-compatible code of the UI script in UI client 130. The code may have been generated at S330 of process 300 as described above. Execution of the code may proceed in a conventional manner, since the architecture of system 100 presumes the execution of UI scripts by UI client 130.

However, if one of the above characteristics is present, it may be determined at S420 to execute the UI script in UI backend 140. Accordingly, at S450, UI client 130 triggers backend 140 to execute the UI script. In some embodiments, such triggering includes executing a script event operation. The backend-compatible code of the UI script is then executed by UI backend 140.

As described above, dynamic determination of script execution requires prior compilation of the UI scripts into compatible code (e.g., ABAP classes). Also, backend UI 140 must support both BO model 150 and UI component model 160. Support for UI component model 160 may include awareness of all relevant UI data entities (including current values) and event entities, the relationships between the entities, and the binding of the entities to BO model 150 and the backend services.

The result of the execution is returned to the UI client at S460. The result may comprise data, layout information and any other suitable result.

According to some embodiments, even if a UI script is executed in the UI backend, the UI script manipulates UI entities of the user interface rather than backend entities of BO model 150. As a result, during debug of the UI script, a developer will sees entities from UI component model in the debugger and not the corresponding backend entities.

In addition to the examples of execution entity determination described above with respect to S420, UI client 130 may also determine, over time, the execution entity which provides optimal execution of a UI script. UI client 130 may thereby consider typical user behavior and complex user interaction in the determination of execution entity. To support this functionality a trace is provided inside the UI script execution at UI backend 140 within test systems. This trace can be imported into the corresponding UI component via UI designer 170. Based upon this trace, UI designer 170 may flag the UI script as suitable for client execution or backend execution.

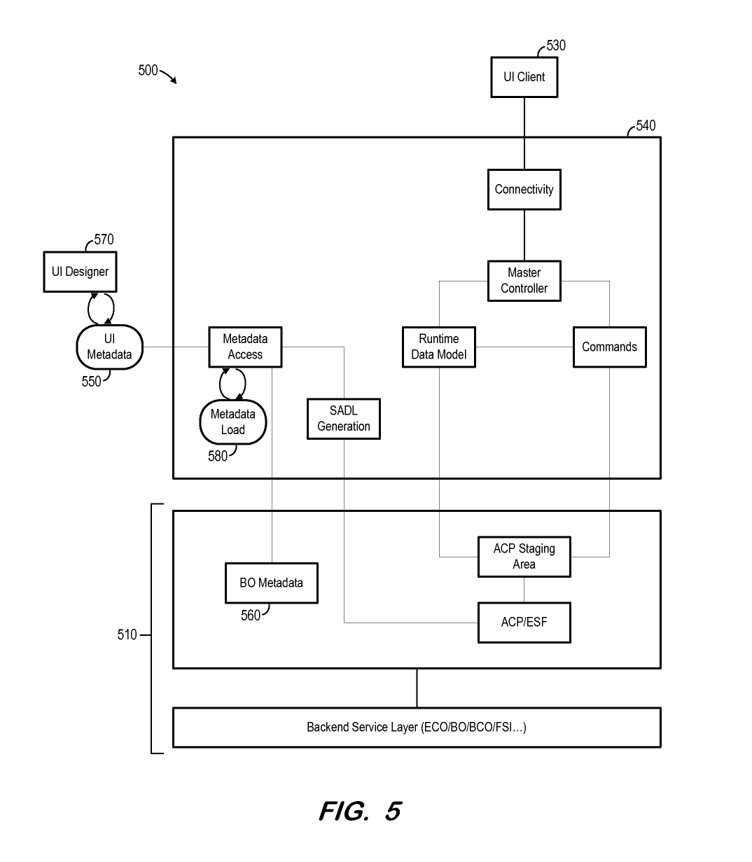

FIG. 5 is a block diagram of an implementation of system 100 according to some embodiments. Each numbered element of system 500 represents an implementation of a correspondingly-numbered element of system 100.

System 500 illustrates both design time and runtime aspects of the embodiments described herein. For example, UI designer 570 may build UI metadata 550 which conforms to a UI component model design, and which is used and evaluated by UI client 530. Moreover, as described above, metadata load 580 is generated at runtime based on UI metadata 550 and business object metadata 560. UI designer 570 may include code executable to perform process 300 and UI client 530 may include code (e.g., a “load balancer”) executable to perform process 400 as described above.

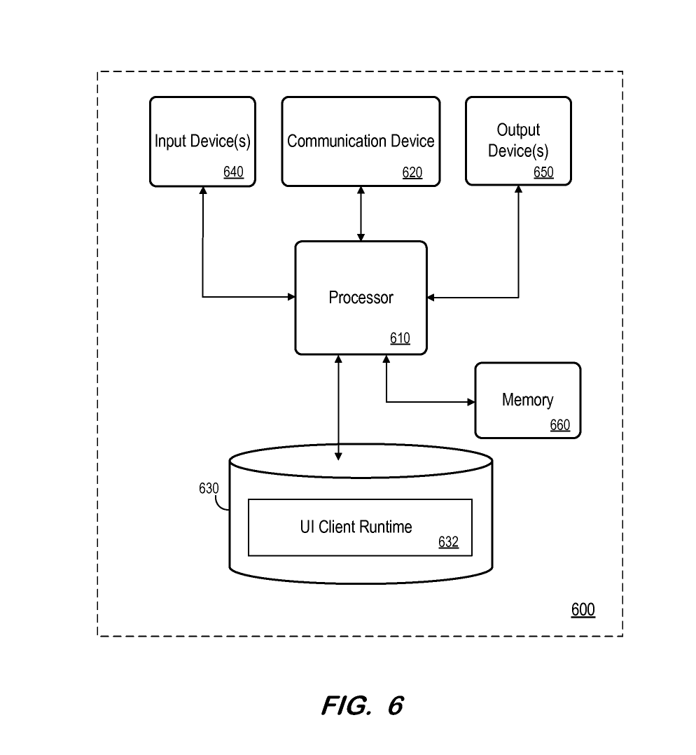

FIG. 6 is a block diagram of apparatus 600 according to some embodiments. Apparatus 600 may comprise a general-purpose computing apparatus and may execute program code to perform any of the functions described herein. Apparatus 600 may comprise an implementation of UI client 130. Apparatus 600 may include other unshown elements according to some embodiments.

Apparatus 600 includes processor 610 operatively coupled to communication device 620, data storage device 630, one or more input devices 640, one or more output devices 650 and memory 660. Communication device 620 may facilitate communication with external devices, such as a reporting client, or a data storage device. Input device(s) 640 may comprise, for example, a keyboard, a keypad, a mouse or other pointing device, a microphone, knob or a switch, an infra-red (IR) port, a docking station, and/or a touch screen. Input device(s) 640 may be used, for example, to enter information into apparatus 600. Output device(s) 650 may comprise, for example, a display (e.g., a display screen) a speaker, and/or a printer.

Data storage device 630 may comprise any appropriate persistent storage device, including combinations of magnetic storage devices (e.g., magnetic tape, hard disk drives and flash memory), optical storage devices, Read Only Memory (ROM) devices, etc., while memory 660 may comprise Random Access Memory (RAM).

Data storage device 630 may store UI client runtime 632, which may be executed by processor 610 to render interfaces which have been designed in view of a UI component model and a BO model of a backend service layer. Program code of UI client runtime 632 may also be executed to perform process 400 in some embodiments. Embodiments are not limited to execution of these processes by a single apparatus. UI client runtime 632 may execute within a virtual machine of, for example, a Web browser.

Data storage device 632 may also store applications such as a word processing program, an e-mail client, a spreadsheet application, and any other suitable applications. Data storage device 630 may also store data and other program code for providing additional functionality and/or which are necessary for operation thereof, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each system described herein may be implemented by any number of devices in communication via any number of other public and/or private networks. Two or more of such computing devices may be located remote from one another and may communicate with one another via any known manner of network(s) and/or a dedicated connection. Each device may comprise any number of hardware and/or software elements suitable to provide the functions described herein as well as any other functions. For example, any computing device used in an implementation of system 100 may include a processor to execute program code such that the computing device operates as described herein.

All systems and processes discussed herein may be embodied in program code stored on one or more computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

Elements described herein as communicating with one another are directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (ATM), Internet Protocol (IP), Hypertext Transfer Protocol (HTTP) and Wireless Application Protocol (WAP).

The embodiments described herein are solely for the purpose of illustration. Those in the art will recognize other embodiments may be practiced with modifications and alterations limited only by the claims.

1. A computer-implemented method comprising:
receiving, from a user interface client application, an instruction to execute a user interface script conforming to a user interface component model;
determining whether to execute the user interface script in the user interface client application or in a user interface backend application;
if it is determined to execute the user interface script in the user interface client application, executing first program code associated with the user interface script in the user interface client application; and
if it is determined to execute the user interface script in the user interface backend application, executing second program code associated with the user interface script in the user interface backend application;
wherein the determining to execute the user interface script in the user interface client application or in a user interface backend application comprises one or more of:
determining whether the user interface script accesses one or more services of a backend service layer, and if so, determining to execute the user interface script in the user interface backend application; and
determining whether the user interface script is associated with an operation of the user interface backend application, and if so, determining to execute the user interface script in the user interface backend application; and
wherein the determining to execute the user interface script in the user interface client application or in a user interface backend application further comprises:
determining to execute the user interface script in the user interface client application if it is not determined to execute the user interface script in the user interface backend application.

2. A computer-implemented method according to claim 1, further comprising:
if it is determined to execute the user interface script in the user interface backend application, execute the second program code associated with the user interface script in the user interface backend application and return a result of the execution to the user interface client application.

3. A computer-implemented method according to claim 2, further comprising:
prior to receiving the instruction, determining if the user interface script is to be executed only in the user interface client application, only in the user interface backend application, or in the user interface client application and the user interface backend application;
if the user interface script is to be executed only in the user interface client application, compiling the user interface script to generate only the first program code;
if the user interface script is to be executed only in the user interface backend application compiling the user interface script to generate only the second program code; and
if the user interface script is to be executed in the user interface client application and the user interface backend application compiling the user interface script to generate the first program code and the second program code.

4. A computer-implemented method according to claim 1, further comprising:
prior to receiving the instruction, determining if the user interface script is to be executed only in the user interface client application, only in the user interface backend application, or in the user interface client application and the user interface backend application;
if the user interface script is to be executed only in the user interface client application, compiling the user interface script to generate only the first program code;
if the user interface script is to be executed only in the user interface backend application compiling the user interface script to generate only the second program code; and
if the user interface script is to be executed in the user interface client application and the user interface backend application compiling the user interface script to generate the first program code and the second program code.

5. (canceled)

6. A non-transitory computer-readable medium storing program code executable by a computing system, the program code comprising:
code to receive, from a user interface client application, an instruction to execute a user interface script conforming to a user interface component model;
code to determine whether to execute the user interface script in the user interface client application or in a user interface backend application;
code to execute, if it is determined to execute the user interface script in the user interface client application, first program code associated with the user interface script in the user interface client application; and
code to execute, if it is determined to execute the user interface script in the user interface backend application, second program code associated with the user interface script in the user interface backend application;
wherein the code to determine to execute the user interface script in the user interface client application or in a user interface backend application comprises one or more of:
code to determine whether the user interface script accesses one or more services of a backend service layer, and if so, to determine to execute the user interface script in the user interface backend application; and
code to determine whether the user interface script is associated with an operation of the user interface backend application, and if so, to determine to execute the user interface script in the user interface backend application; and
wherein the code to determine to execute the user interface script in the user interface client application or in a user interface backend application further comprises:
code to determine to execute the user interface script in the user interface client application if it is not determined to execute the user interface script in the user interface backend application.

7. A medium according to claim 6, the code to execute the second program code further comprising:
code to return a result of the execution to the user interface client application.

8. A medium according to claim 7, further comprising:
code to determine, prior to receiving the instruction, if the user interface script is to be executed only in the user interface client application, only in the user interface backend application, or in the user interface client application and the user interface backend application;
code to compile the user interface script to generate only the first program code if the user interface script is to be executed only in the user interface client application;
code to compile the user interface script to generate only the second program code if the user interface script is to be executed only in the user interface backend application; and
code to compile the user interface script to generate the first program code and the second program code if the user interface script is to be executed in the user interface client application and the user interface backend application.

9. A medium according to claim 6, further comprising:
code to determine, prior to receiving the instruction, if the user interface script is to be executed only in the user interface client application, only in the user interface backend application, or in the user interface client application and the user interface backend application;
code to compile the user interface script to generate only the first program code if the user interface script is to be executed only in the user interface client application;
code to compile the user interface script to generate only the second program code if the user interface script is to be executed only in the user interface backend application; and
code to compile the user interface script to generate the first program code and the second program code if the user interface script is to be executed in the user interface client application and the user interface backend application.

10. (canceled)

11. A computing system comprising:
a memory storing processor-executable process steps; and
a processor to execute the processor-executable process steps to cause the system to:
receive, from a user interface client application, an instruction to execute a user interface script conforming to a user interface component model;
determine whether to execute the user interface script in the user interface client application or in a user interface backend application;
execute, if it is determined to execute the user interface script in the user interface client application, first program code associated with the user interface script in the user interface client application; and
execute, if it is determined to execute the user interface script in the user interface backend application, second program code associated with the user interface script in the user interface backend application;
wherein the determination to execute the user interface script in the user interface client application or in a user interface backend application comprises one or more of:
determination of whether the user interface script accesses one or more services of a backend service layer, and if so, determination to execute the user interface script in the user interface backend application; and
determination of whether the user interface script is associated with an operation of the user interface backend application, and if so, determination to execute the user interface script in the user interface backend application; and
wherein the determination to execute the user interface script in the user interface client application or in a user interface backend application further comprises:
determination to execute the user interface script in the user interface client application if it is not determined to execute the user interface script in the user interface backend application.

12. A system according to claim 11, wherein execution of the second program code further comprises:
returning of a result of the execution to the user interface client application.

13. A system according to claim 12, the processor to further execute the processor-executable process steps to cause the system to:
determine, prior to receiving the instruction, if the user interface script is to be executed only in the user interface client application, only in the user interface backend application, or in the user interface client application and the user interface backend application;
compile the user interface script to generate only the first program code if the user interface script is to be executed only in the user interface client application;
compile the user interface script to generate only the second program code if the user interface script is to be executed only in the user interface backend application; and
compile the user interface script to generate the first program code and the second program code if the user interface script is to be executed in the user interface client application and the user interface backend application.

14. A system according to claim 11, the processor to execute the processor-executable process steps to cause the system to:
determine, prior to receiving the instruction, if the user interface script is to be executed only in the user interface client application, only in the user interface backend application, or in the user interface client application and the user interface backend application;
compile the user interface script to generate only the first program code if the user interface script is to be executed only in the user interface client application;
compile the user interface script to generate only the second program code if the user interface script is to be executed only in the user interface backend application; and
compile the user interface script to generate the first program code and the second program code if the user interface script is to be executed in the user interface client application and the user interface backend application.

15. (canceled)
